(19) United States
(12) Patent Application Publication
(10) Pub. No.: US 2016/0197800 A1
(43) Pub. Date: Jul. 7, 2016

(54) DYNAMICALLY ADJUSTING NETWORK OPERATIONS USING PHYSICAL SENSOR INPUTS

(71) Applicant: Cisco Technology, Inc., San Jose, CA (US)

(72) Inventors: Jonathan W. Hui, Belmont, CA (US); Jean-Philippe Vasseur, Saint Martin d'Uriage (FR); Wei Hong, Berkeley, CA (US)

(21) Appl. No.: 14/590,080

(22) Filed: Jan. 6, 2015

(51) Int. Cl. H04L 12/26; H04L 12/24; H04L 29/08

(52) U.S. Cl. CPC H04L 43/062; H04L 67/12; H04L 41/0853

(57) ABSTRACT

In one embodiment, a device in a network receives sensor data regarding one or more physical conditions external to the network. The device determines at least one of: a traffic profile based on the sensor data or a condition of the network based on the sensor data. The device adjusts an operation of the network, based on the at least one of the determined traffic profile or the determined condition of the network.

### TECHNICAL FIELD

The present disclosure relates generally to computer networks, and, more particularly, to dynamically adjusting network operations using physical sensor inputs.

### BACKGROUND

Low power and Lossy Networks (LLNs), e.g., sensor networks, have a myriad of applications, such as Smart Grid and Smart Cities. Various challenges are presented with LLNs, such as lossy links, low bandwidth, battery operation, low memory and/or processing capability of a device, etc. Changing environmental conditions may also affect device communications. For example, physical obstructions (e.g., changes in the foliage density of nearby trees, the opening and closing of doors, etc.), changes in interference (e.g., from other wireless networks or devices), propagation characteristics of the media (e.g., temperature or humidity changes, etc.), and the like, also present unique challenges to LLNs.

Typically, a number of operational tradeoffs are made in LLNs, due to the severely limited resources of the network devices. For example, overall network capacity and latency may be balanced against the need to conserve energy consumption by the devices. In particular, the transceiver of an LLN device may be powered down to conserve energy consumed by the device, at the expense of being able to perform idle listening (e.g., the transceiver's duty cycle may present a tradeoff between energy consumption and the latency/capacity of the device). Consequently, other devices attempting to communicate with the device may be required to wait until the device powers on its transceiver again. In another example, wireless backoff parameters may represent another tradeoff between latency and network density. In particular, reducing media access control (MAC) backoff parameters supports lower communication latency but also increases the likelihood of packet collisions when contention occurs. In yet another example, a tradeoff may be made at the network layer between using proactive and reactive routing. Generally, proactive networking maintains routes at all times, allowing devices to route traffic without first having to discover a path. Reactive routing, on the other hand, only discovers a path when it is needed and, as a result, does not require any control overhead when packets are not being routed.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates an example view of the communication network with respect to power-line communication (PLC);

FIG. 4 illustrates an example directed acyclic graph (DAG) in the communication network;

FIGS. 5A-5D illustrate an example of the operation of the network being adjusted based on a physical condition external to the network;

FIGS. 6A-6C illustrate an example of a supervisory device adjusting an operation of the network;

FIGS. 7A-7B illustrate examples of a network operation adjustment policy being used;

FIGS. 8A-8C illustrate a feedback mechanism for network operation adjustments;

FIG. 9 illustrates an example simplified procedure for adjusting an operation of a network based on a physical condition external to the network;

FIG. 10 illustrates an example simplified procedure for using feedback to change a network operation adjustment strategy; and

FIG. 11 illustrates an example simplified procedure for using a supervisory device to adjust an operation of a network based on a physical condition external to the network.

### DESCRIPTION OF EXAMPLE EMBODIMENTS

### Overview

According to one or more embodiments of the disclosure, a device in a network receives sensor data regarding one or more physical conditions external to the network. The device determines at least one of: a traffic profile based on the sensor data or a condition of the network based on the sensor data. The device adjusts an operation of the network, based on the at least one of the determined traffic profile or the determined condition of the network.

In further embodiments, a first device in a network receives sensor data from one or more sensors configured to measure one or more physical conditions external to the network. The first device provides the sensor data to a supervisory device in the network. The first device receives an instruction from the supervisory device to adjust an operation of the network, in response to providing the sensor data to the supervisory device. The first device adjusts the operation of the network, in response to receiving the instruction from the supervisory device.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), etc. Generally, size and cost constraints on smart object nodes (e.g., sensors) result in corresponding constraints on resources such as energy, memory, computational speed and bandwidth.

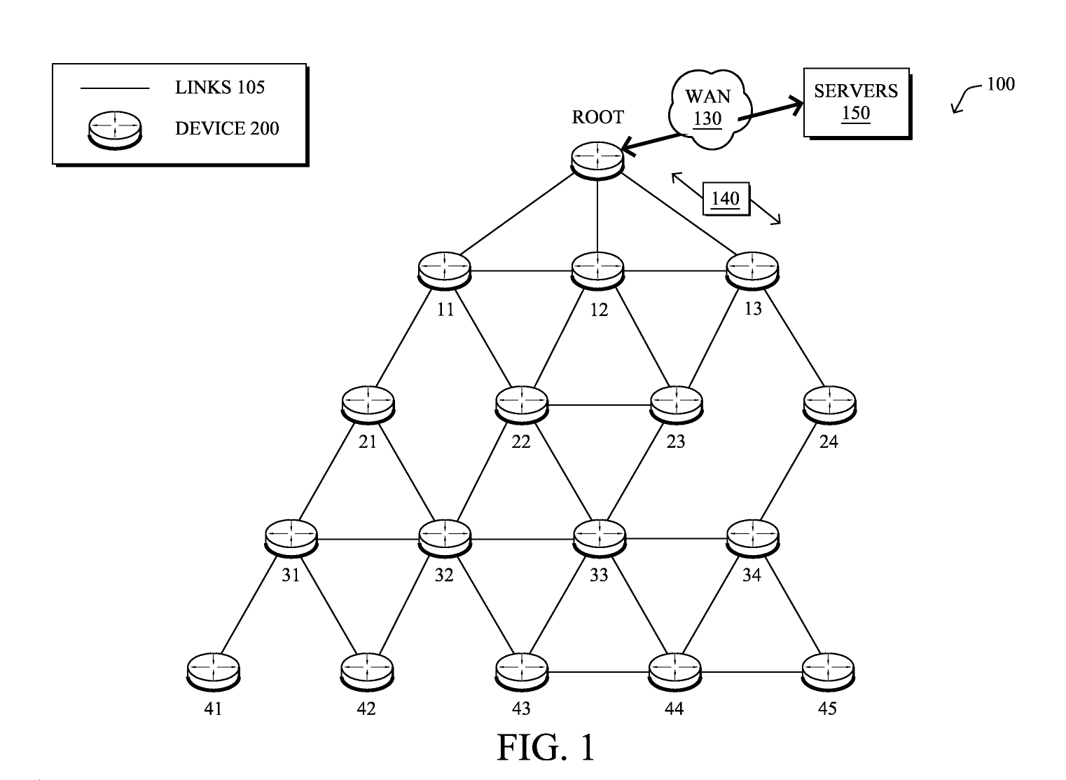

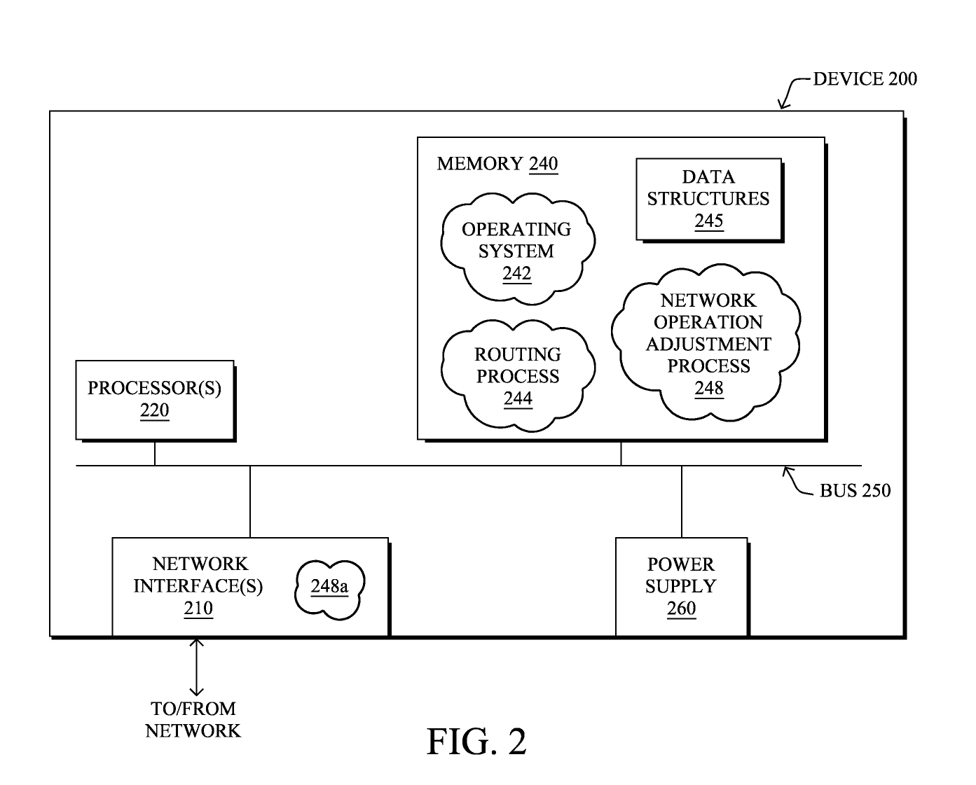

FIG. 1 is a schematic block diagram of an example computer network 100 illustratively comprising nodes/devices 200 (e.g., labeled as shown, “root,” “11,” “12,” . . . “45,” and described in FIG. 2 below) interconnected by various methods of communication. For instance, the links 105 may be wired links or shared media (e.g., wireless links, PLC links, etc.) where certain nodes 200, such as, e.g., routers, sensors, computers, etc., may be in communication with other nodes 200, e.g., based on distance, signal strength, current operational status, location, etc. The illustrative root node, such as a field area router (FAR), may interconnect the local networks with a WAN 130, which may enable communication with other relevant devices such as management devices or servers 150, e.g., a network management server (NMS), a dynamic host configuration protocol (DHCP) server, a constrained application protocol (CoAP) server, an outage management system (OMS), etc. Those skilled in the art will understand that any number of nodes, devices, links, etc. may be used in the computer network, and that the view shown herein is for simplicity. Also, those skilled in the art will further understand that while the network is shown in a certain orientation, particularly with a “root” node, the network 100 is merely an example illustration that is not meant to limit the disclosure.

Data packets 140 (e.g., traffic and/or messages sent between the devices/nodes) may be exchanged among the nodes/devices of the computer network 100 using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the nodes interact with each other.

FIG. 2 is a schematic block diagram of an example node/device 200 that may be used with one or more embodiments described herein, e.g., as any of the nodes shown in FIG. 1 above. The device may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

The network interface(s) 210 include the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration. Also, while the network interface 210 is shown separately from power supply 260, for PLC the network interface 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise routing process/services 244 and an illustrative network operation adjustment process 248, as described herein. Note that while network operation adjustment process 248 is shown in centralized memory 240, alternative embodiments provide for the process to be specifically operated within the network interfaces 210, such as a component of a MAC layer (process “248a”).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process (services) 244 includes computer executable instructions executed by the processor 220 to perform functions provided by one or more routing protocols, such as proactive or reactive routing protocols as will be understood by those skilled in the art. These functions may, on capable devices, be configured to manage a routing/forwarding table (a data structure 245) including, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

An example protocol specified in an Internet Engineering Task Force (IETF) Proposed Standard, Request for Comment (RFC) 6550, entitled “RPL: IPv6 Routing Protocol for Low Power and Lossy Networks” by Winter, et al. (March 2012), provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

A DAG is a directed graph having the property that all edges (and/or vertices) are oriented in such a way that no cycles (loops) are supposed to exist. All edges are included in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Further, in certain embodiments, a sibling of a node within a DAG may be defined as any neighboring node which is located at the same rank within a DAG. Note that siblings do not necessarily share a common parent, and routes between siblings are generally not part of a DAG since there is no forward progress (their rank is the same). Note also that a tree is a kind of DAG, where each device/node in the DAG generally has one parent or one preferred parent.

DAGs may generally be built (e.g., by routing process 244) based on an Objective Function (OF). The role of the Objective Function is generally to specify rules on how to build the DAG (e.g. number of parents, backup parents, etc.).

In addition, one or more metrics/constraints may be advertised by the routing protocol to optimize the DAG against. Also, the routing protocol allows for including an optional set of constraints to compute a constrained path, such as if a link or a node does not satisfy a required constraint, it is “pruned” from the candidate list when computing the best path. (Alternatively, the constraints and metrics may be separated from the OF.) Additionally, the routing protocol may include a “goal” that defines a host or set of hosts, such as a host serving as a data collection point, or a gateway providing connectivity to an external infrastructure, where a DAG's primary objective is to have the devices within the DAG be able to reach the goal. In the case where a node is unable to comply with an objective function or does not understand or support the advertised metric, it may be configured to join a DAG as a leaf node. As used herein, the various metrics, constraints, policies, etc., are considered “DAG parameters.”

Illustratively, example metrics used to select paths (e.g., preferred parents) may comprise cost, delay, latency, bandwidth, expected transmission count (ETX), etc., while example constraints that may be placed on the route selection may comprise various reliability thresholds, restrictions on battery operation, multipath diversity, bandwidth requirements, transmission types (e.g., wired, wireless, etc.). The OF may provide rules defining the load balancing requirements, such as a number of selected parents (e.g., single parent trees or multi-parent DAGs). Notably, an example for how routing metrics and constraints may be obtained may be found in an IETF RFC, entitled “Routing Metrics used for Path Calculation in Low Power and Lossy Networks”<RFC 6551> by Vasseur, et al. (March 2012 version). Further, an example OF (e.g., a default OF) may be found in an IETF RFC, entitled “RPL Objective Function 0”<RFC 6552> by Thubert (March 2012 version) and “The Minimum Rank Objective Function with Hysteresis” <RFC 6719> by O. Gnawali et al. (September 2012 version).

Building a DAG may utilize a discovery mechanism to build a logical representation of the network, and route dissemination to establish state within the network so that routers know how to forward packets toward their ultimate destination. Note that a “router” refers to a device that can forward as well as generate traffic, while a “host” refers to a device that can generate but does not forward traffic. Also, a “leaf” may be used to generally describe a non-router that is connected to a DAG by one or more routers, but cannot itself forward traffic received on the DAG to another router on the DAG. Control messages may be transmitted among the devices within the network for discovery and route dissemination when building a DAG.

According to the illustrative RPL protocol, a DODAG Information Object (DIO) is a type of DAG discovery message that carries information that allows a node to discover a RPL Instance, learn its configuration parameters, select a DODAG parent set, and maintain the upward routing topology. In addition, a Destination Advertisement Object (DAO) is a type of DAG discovery reply message that conveys destination information upwards along the DODAG so that a DODAG root (and other intermediate nodes) can provision downward routes. A DAO message includes prefix information to identify destinations, a capability to record routes in support of source routing, and information to determine the freshness of a particular advertisement. Notably, “upward” or “up” paths are routes that lead in the direction from leaf nodes towards DAG roots, e.g., following the orientation of the edges within the DAG. Conversely, “downward” or “down” paths are routes that lead in the direction from DAG roots towards leaf nodes, e.g., generally going in the opposite direction to the upward messages within the DAG.

Generally, a DAG discovery request (e.g., DIO) message is transmitted from the root device(s) of the DAG downward toward the leaves, informing each successive receiving device how to reach the root device (that is, from where the request is received is generally the direction of the root). Accordingly, a DAG is created in the upward direction toward the root device. The DAG discovery reply (e.g., DAO) may then be returned from the leaves to the root device(s) (unless unnecessary, such as for UP flows only), informing each successive receiving device in the other direction how to reach the leaves for downward routes. Nodes that are capable of maintaining routing state may aggregate routes from DAO messages that they receive before transmitting a DAO message. Nodes that are not capable of maintaining routing state, however, may attach a next-hop parent address. The DAO message is then sent directly to the DODAG root that can in turn build the topology and locally compute downward routes to all nodes in the DODAG. Such nodes are then reachable using source routing techniques over regions of the DAG that are incapable of storing downward routing state. In addition, RPL also specifies a message called the DIS (DODAG Information Solicitation) message that is sent under specific circumstances so as to discover DAG neighbors and join a DAG or restore connectivity.

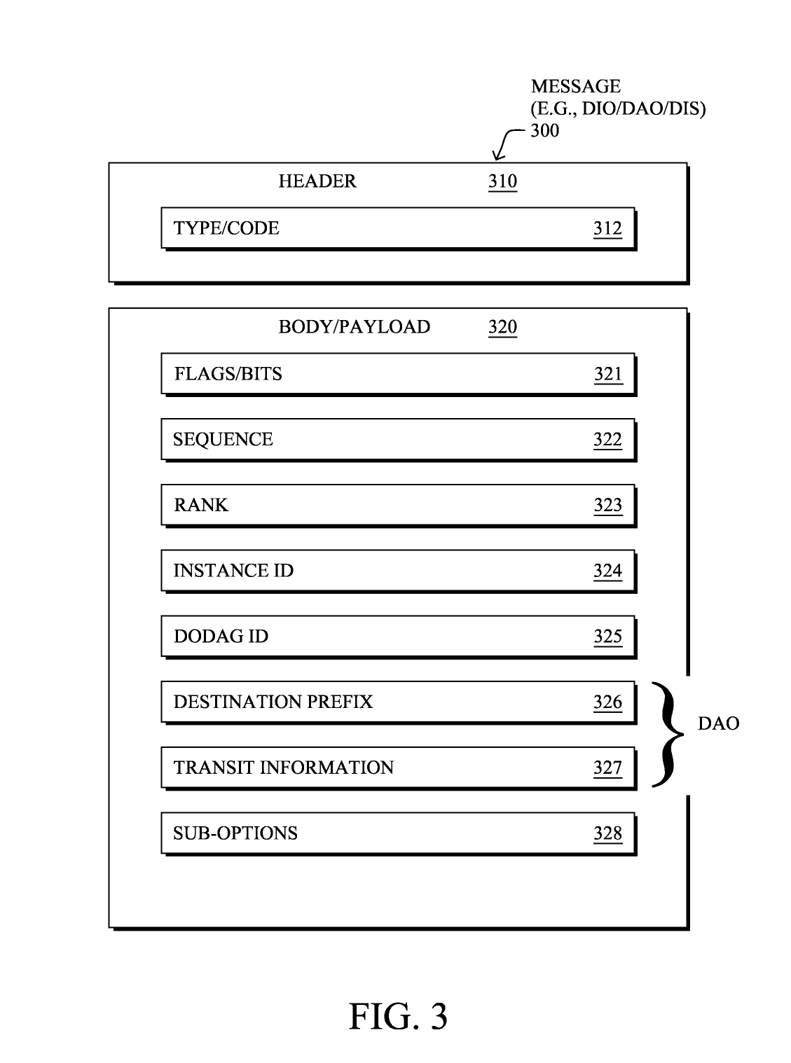

FIG. 3 illustrates an example simplified control message format 300 that may be used for discovery and route dissemination when building a DAG, e.g., as a DIO, DAO, or DIS message. Message 300 illustratively comprises a header 310 with one or more fields 312 that identify the type of message (e.g., a RPL control message), and a specific code indicating the specific type of message, e.g., a DIO, DAO, or DIS. Within the body/payload 320 of the message may be a plurality of fields used to relay the pertinent information. In particular, the fields may comprise various flags/bits 321, a sequence number 322, a rank value 323, an instance ID 324, a DODAG ID 325, and other fields, each as may be appreciated in more detail by those skilled in the art. Further, for DAO messages, additional fields for destination prefixes 326 and a transit information field 327 may also be included, among others (e.g., DAO_Sequence used for ACKs, etc.). For any type of message 300, one or more additional sub-option fields 328 may be used to supply additional or custom information within the message 300. For instance, an objective code point (OCP) sub-option field may be used within a DIO to carry codes specifying a particular objective function (OF) to be used for building the associated DAG. Alternatively, sub-option fields 328 may be used to carry other certain information within a message 300, such as indications, requests, capabilities, lists, notifications, etc., as may be described herein, e.g., in one or more type-length-value (TLV) fields.

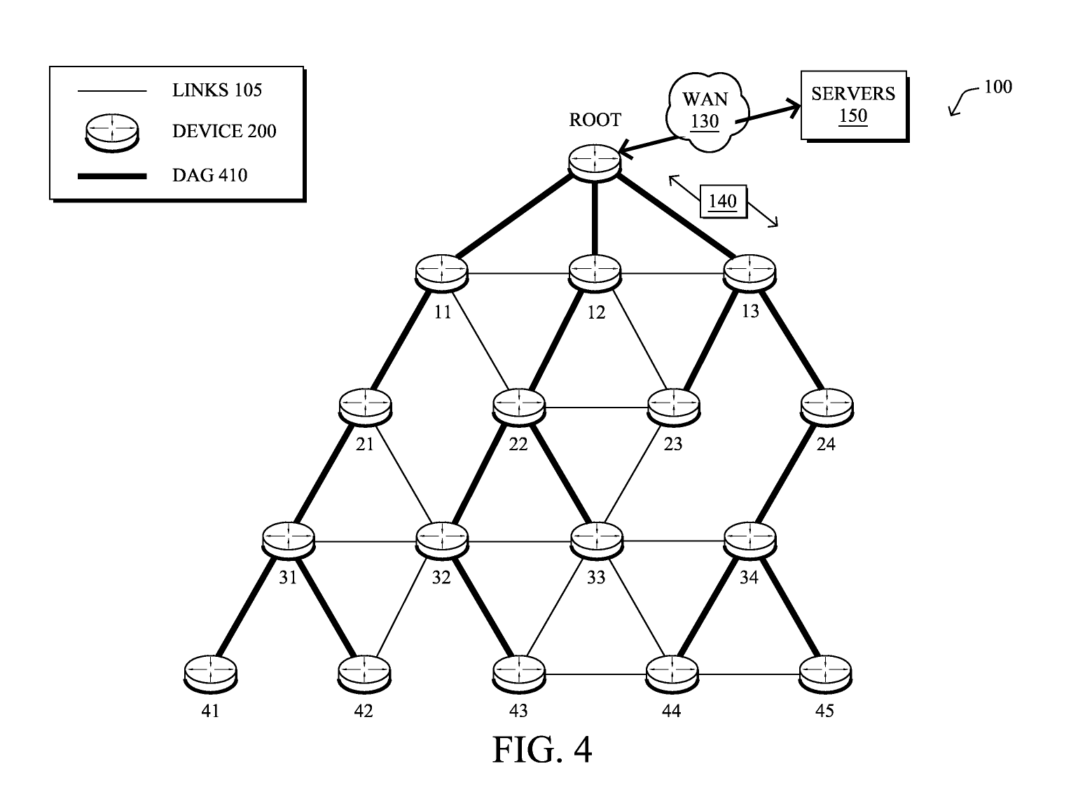

FIG. 4 illustrates an example simplified DAG that may be created, e.g., through the techniques described above, within network 100 of FIG. 1. For instance, certain links 105 may be selected for each node to communicate with a particular parent (and thus, in the reverse, to communicate with a child, if one exists). These selected links form the DAG 410 (shown as bolded lines), which extends from the root node toward one or more leaf nodes (nodes without children). Traffic/packets 140 (shown in FIG. 1) may then traverse the DAG 410 in either the upward direction toward the root or downward toward the leaf nodes, particularly as described herein.

As noted above, a number of tradeoffs may be made with respect to the operation of an LLN (e.g., balancing energy consumption vs. throughput/latency, balancing network density vs. latency, etc.). Typically, the network parameters that control these tradeoffs are set manually by a network operator (e.g., a network administrator), prior to deployment of the network. For example, the network operator may choose the operational parameters of the network based on the specific applications that will be supported by the network (e.g., distributed automation, smart grid AMI, etc.). After network deployment, some mechanisms may be used to adjust the operation of the network based on the observed performance of the network. For example, as described above, the routing topology and/or other network parameters may be dynamically adjusted based on the measured amount of link-layer contention, node density, traffic throughput, latency, dropped packets, jitter, etc. present in the network. In some cases, network parameters may also be adjusted dynamically based on explicit service requests from an application. For example, an application may request X kbps of capacity towards a destination and, in response, the network may allocate the corresponding resources.

Thus far, network operation adjustments in LLNs have been made without respect to the external conditions that necessitated the change. For example, a routing topology change may be initiated within an LLN, in response to a decline in link quality between network nodes. However, the decline in link quality may be caused by any number of physical conditions external to the network (e.g., the presence of fog, rain, etc.). In addition, the tradeoffs between different network operations are typically made without respect to the physical conditions external to the network.

Dynamically Adjusting Network Operations Using Physical Sensor Inputs

The techniques herein allow for network operations to be adjusted dynamically based on physical sensor data available to a device regarding one or more physical conditions external to the network. In one aspect, the correlation between the sensor data and the traffic profile may be modeled. In another aspect, the correlation between the sensor data and the network conditions (e.g., link-layer channel characteristics, etc.) may be modeled. In a further aspect, one or more network parameters/operations may be adjusted based on the predicted traffic profile and network conditions provided by the models. In yet another aspect, a supervisory device may receive sensor data from one or more other devices and initiate a network operation change by providing instructions to the one or more other devices based on the sensor data. In another aspect, a network operation adjustment policy may be used in the network, to control which operational parameters may be changed and/or how the changes may be made (e.g., by specifying a parameter range, etc.). In an additional aspect, a feedback mechanism is disclosed herein that allows the network operation adjustment strategy to be changed, based on performance metrics associated with making an operational change in the network due to received sensor data.

Specifically, according to one or more embodiments of the disclosure as described in detail below, a device in a network receives sensor data regarding one or more physical conditions external to the network. The device determines at least one of: a traffic profile based on the sensor data or a condition of the network based on the sensor data. The device adjusts an operation of the network, based on the at least one of the determined traffic profile or the determined condition of the network.

Illustratively, the techniques described herein may be performed by hardware, software, and/or firmware, such as in accordance with the network operation adjustment process 248/248a, which may include computer executable instructions executed by the processor 220 (or independent processor of interfaces 210) to perform functions relating to the techniques described herein, e.g., in conjunction with routing process 244. For example, the techniques herein may be treated as extensions to conventional protocols, such as the various PLC protocols or wireless communication protocols, and as such, may be processed by similar components understood in the art that execute those protocols, accordingly.

Operationally, an LLN may function as a sensor network, where some or all of the network devices are equipped with sensors/actuators that measure physical phenomena external to the network itself. For example, LLN devices used in smart metering applications may have sensors to measure line voltage and current and actuators that perform power cut-off. In another example, LLN devices in home/building automation deployments may have sensors that monitor light, temperature, humidity, etc. and/or actuators that control heating/cooling, lighting, etc. In yet another example, LLN devices used for agricultural applications may have sensors that monitor light, temperature, humidity, soil moisture, etc.

In contrast to traditional networks, traffic in sensor networks may be correlated to physical sensor data. For example, a significant change in a particular sensor reading may cause additional traffic to be generated in a sensor network. However, in other cases, the relationship between the traffic profile and the sensor readings may be more indirect. For example, in home/building automation networks, sensor data from light and occupancy sensors that simply detect human activity may still be correlated with traffic pattern changes in the network (e.g., due to an increase in the number of users present that may interact with the LLN devices).

According to various embodiments, mechanisms are introduced herein that dynamically adjust operations of the network (e.g., by adjusting network parameters) based on physical sensor data available to a given network device. In particular, the sensor data may be used to model the traffic profiles and the conditions of the network. The predicted traffic profile and network conditions may then be used to dynamically adjust the operation of the network (e.g., by adjusting network parameters, by triggering one or more network nodes to perform actions, etc.). Notably, the techniques herein use sensor data from physical sensors that do not directly measure existing network state to trigger operational changes in the network at a local device and/or via one or more remote nodes in the network.

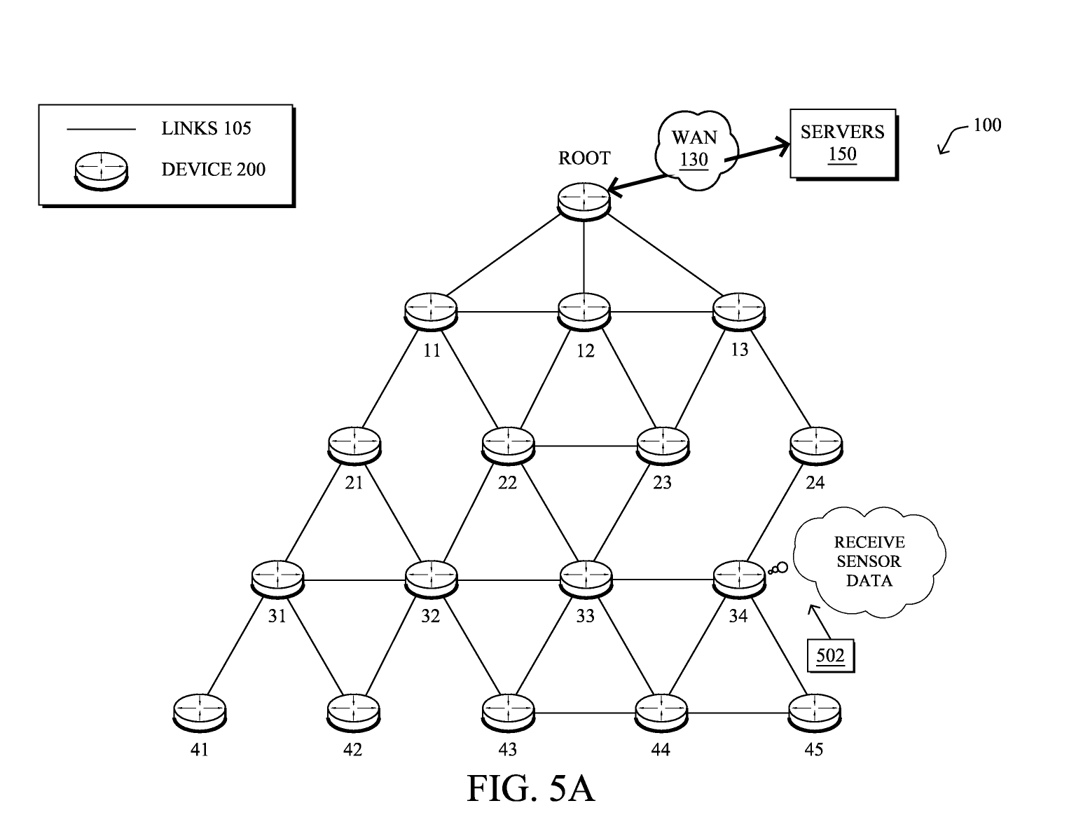

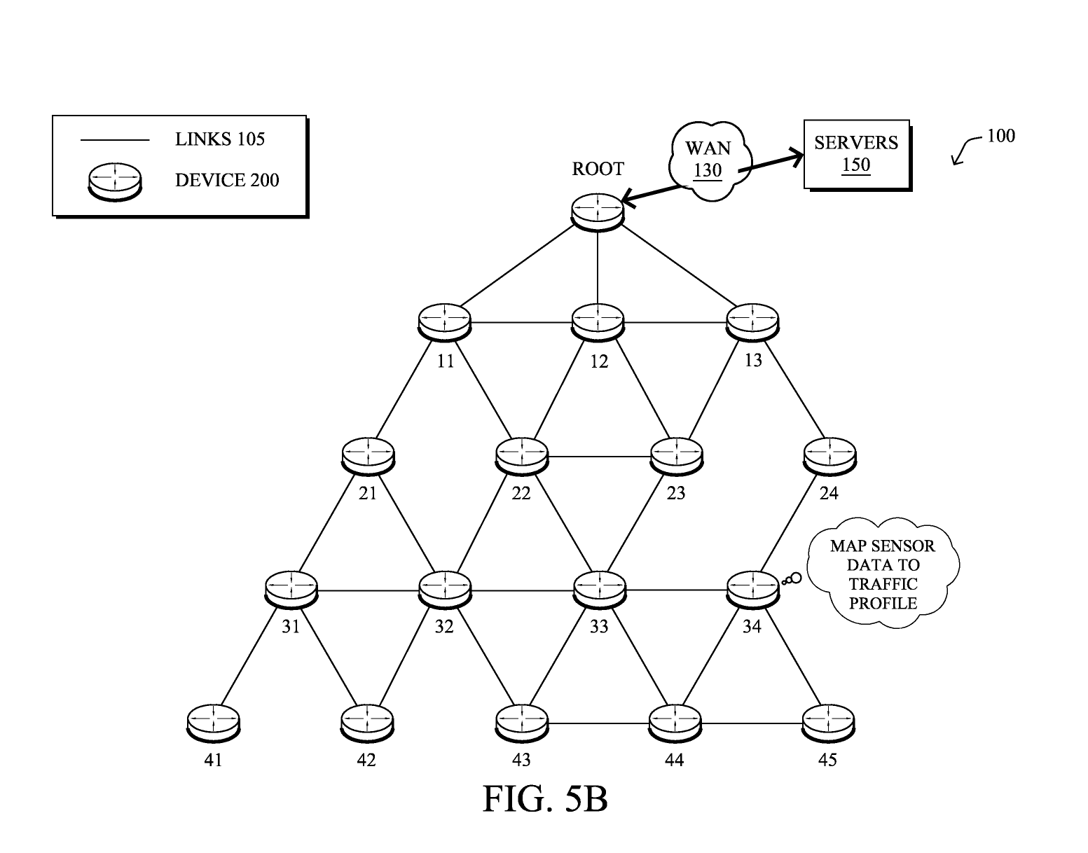

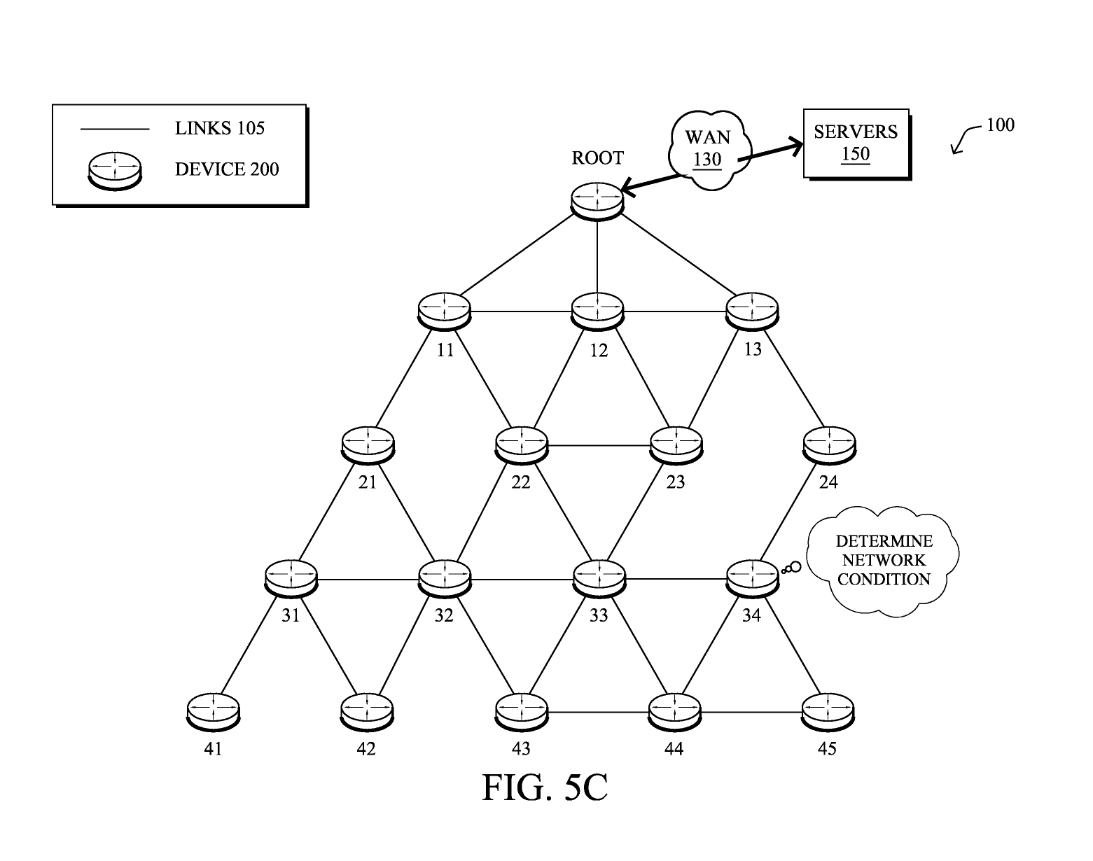

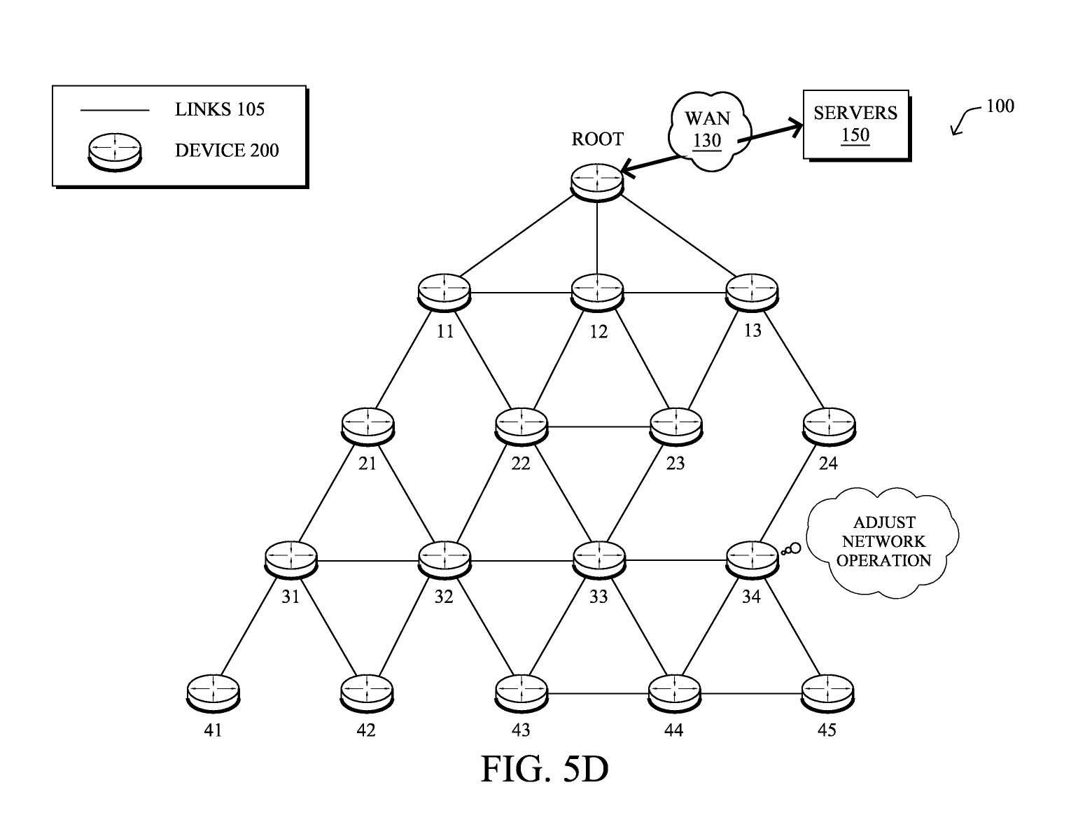

Referring now to FIGS. 5A-5D, an example is shown of the operation of the network being adjusted based on a physical condition external to the network, according to various embodiments. In some embodiments, a device in the network may receive sensor data from one or more sensors configured to monitor physical conditions external to the network itself. For example, as shown in FIG. 5A, a node/device 34 may receive sensor data 502 from one or more sensors in the network. In some embodiments, sensor data 502 may be generated by one or more sensors of the device itself (e.g., by one or more sensors of node 34). In other embodiments, as shown, node 34 may receive sensor data 502 from one or more other nodes/devices of network 100 (e.g., from node 45, etc.).

Sensor data 502 may include any measurements regarding the physical conditions external to network 100. For example, sensor data 502 may be generated or derived from measurements taken by a light sensor, a temperature sensor, a sound sensor, a barometer, a humidity sensor, a motion sensor, a building occupancy sensor (e.g., a security keypad, a card reader, a biometric reader, a camera, etc.), a vibration sensor, an accelerometer, combinations thereof, or the like. In some cases, sensor data 502 includes the raw data generated directly by the sensor(s). In other cases, sensor data 502 may include calculations derived from the raw sensor measurements (e.g., an average temperature, etc.).

In one aspect of the techniques herein, a device may use sensor data to determine/predict a traffic profile and/or application requirements. For example, as shown in FIG. 5B, device 34 may use the received sensor data 502 to predict a traffic profile that is correlated to the received sensor data. In general, a traffic profile characterizes the types of traffic present in the network (e.g., the applications associated with the different traffic flows, any priorities associated with the traffic flows, whether the traffic is broadcast or unicast, etc.), the routing paths/devices associated with the traffic flows, the resource usage by the traffic flows (e.g., bandwidth, etc.), and any other information that can be used to characterize the traffic in the network. In one embodiment, the device may determine the traffic profile based on a preconfigured mapping between sensor data and traffic profiles. In some cases, device 34 may use a preconfigured mapping provided to device 34 from a network operator via a user interface (e.g., a keypad, a touch screen display, a pointing device, etc.), to determine/predict the expected traffic profile. For example, a network operator may indicate that an increase in the building's occupancy may correspond to an increase in the amount of traffic in network 100.

In some embodiments, a device may use machine learning techniques, to determine the traffic profile based on the sensor data. Notably, sensor data samples may be used with observations regarding traffic in the network, to construct a machine learning model that maps sensor data to traffic profiles. Such a model may be very lightweight and still capable of building highly granular traffic profiles. For example, a network device may use one or more Gaussian Mixture Models that mix any number of weighted Gaussian distributions of input parameters in a multi-dimensional space. In another embodiment, the device may use a time-series model to profile the traffic. For example, the device may determine the traffic profile using an autoregressive-moving-average model (ARMA) or the like. Such a model may be trained over time using observations regarding the sensor data and the observed traffic in the network. For example, the model may be trained over time to associate data from sensors that determine occupancy (e.g., light sensors, passive infrared sensors, etc.) with an increased need for network capacity and reduced communication latency, at the expense of the device's lifetime (e.g., by keeping the transceiver of the device active longer).

In one example of operation, assume that a particular node in the network typically begins sending traffic shortly after a nearby motion sensor detects the presence of a user. Both the sensor data and the network traffic profile information may be used as inputs to a machine learning model. Over time, such a model may begin to correlate detected motion from the sensor with a change in the network traffic (e.g., an increase in traffic sent from the particular device).

A network device that receives sensor data may use the sensor data to determine a condition of the network, according to various embodiments. For example, as shown in FIG. 5C, device 34 may use sensor data 502 to determine a network condition. In general, a network condition corresponds to a level of performance or state of the network itself. For example, sensor data from a light sensor may indicate that significant variations in temperature exist between outdoor devices in close physical proximity of one another (e.g., devices in direct sunlight may experience much higher temperatures than those in shade). Temperature variations can affect clock drift rates and time synchronization necessary for communication. Thus, in such a case, the network condition may correspond to a device in direct sunlight being deemed more susceptible to clock drift. In another example, sensor data from one or more occupancy sensors in a building may indicate a greater likelihood of environmental changes that may affect wireless link quality (e.g., doors closing, people moving, etc.).

In some embodiments, an operation of the network may be adjusted based on the sensor data regarding one or more physical conditions external to the network. In particular, a device may adjust an operation of the network based on the condition of the network and/or the traffic profile determined using the sensor data (e.g., by adjusting one or more parameters that control how the network operates). For example, as shown in FIG. 5D, device 34 may adjust one or more parameters that affect the operation of the network, based on the traffic profile and/or network condition determined from sensor data 502. Example parameters that affect the operation of the network may include, but are not limited to, parameters that affect the routing topology (e.g., how frequently routing updates are propagated, how frequently link quality metrics are evaluated, the objective function used to build the topology, etc.), parameters that affect clock synchronization between network devices, parameters that control routing decisions (e.g., when packets should be rerouted, etc.), parameters that control an energy conservation mechanisms used by network devices (e.g., by powering up or down the transceiver of a device, by powering up or down a device itself, etc.), parameters that control traffic flows (e.g., traffic priorities, routing paths for particular types of traffic, etc.), parameters that affect one or more network performance metrics (e.g., link quality metrics, jitter, delay, packet loss/retransmissions, etc.), combinations thereof, or the like. Further network operations that may be adjusted may also include switching between proactive and reactive routing mechanisms, switching between building a multicast routing tree vs. flooding multicast messages, adjusting the capacity tradeoff between broadcast and unicast traffic, switching between sending broadcast messages vs. sending a plurality of unicast messages, etc.

As would be appreciated, the limited resources of LLN devices and changing environmental conditions typical to LLNs often require a tradeoff to be made between competing goals for the network (e.g., conserving device power consumption, providing acceptable network performance, etc.). Accordingly, the traffic profile and/or network condition determined from the physical sensor data may be used to adjust these tradeoffs. For example, a predicted increase in the traffic profile from the sensor data (e.g., based on data from occupancy sensors, etc.) may cause the network to favor performance over energy conservation and vice-versa for a predicted decrease in the traffic profile. In another example, adjustments may be made to offset any potential changes to the condition of the network due to changing environmental conditions (e.g., decreased link quality due to increased building occupancy, the presence of fog or rain, etc.).

In some cases, a change in either the predicted traffic profile or the condition of the network may offset any need to adjust the operation of the network. For example, decreased network performance due to environmental/weather conditions may not necessitate an adjustment to the operation of the network, if the traffic profile indicates low use of the network and the actual traffic is of low priority (e.g., the building is effectively vacant during a holiday and, consequently, the network traffic is extremely low, etc.). However, in other cases, the type of traffic may still necessitate a change in the operation of the network to accommodate an environmental change, even if the volume of traffic is low (e.g., device reporting may be scheduled for off-hours, etc.).

Various examples of the techniques herein are as follows. In one example, the frequency at which clock resynchronization messages are sent between devices may be adjusted, based on a measured or predicted temperature difference between network nodes (e.g., based on data from a temperature sensor, presumed from different light-sensor measurements between devices, etc.). In another example, the frequency at which link qualities are evaluated and routing updates are propagated may be increased, based on a sensed increase in building occupancy or weather condition (e.g., fog, rain, etc.). In yet another example, routes may be constructed between devices that are likely to be used in the future (e.g., based on data from a light or occupancy sensor, etc.).

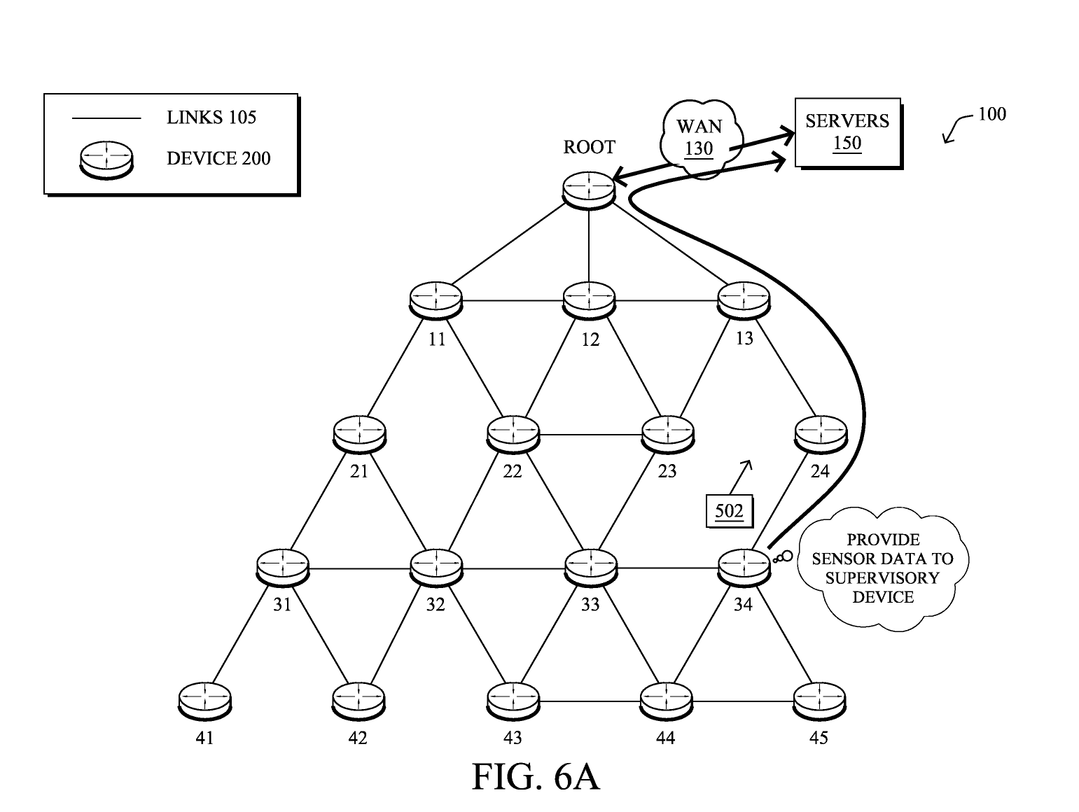

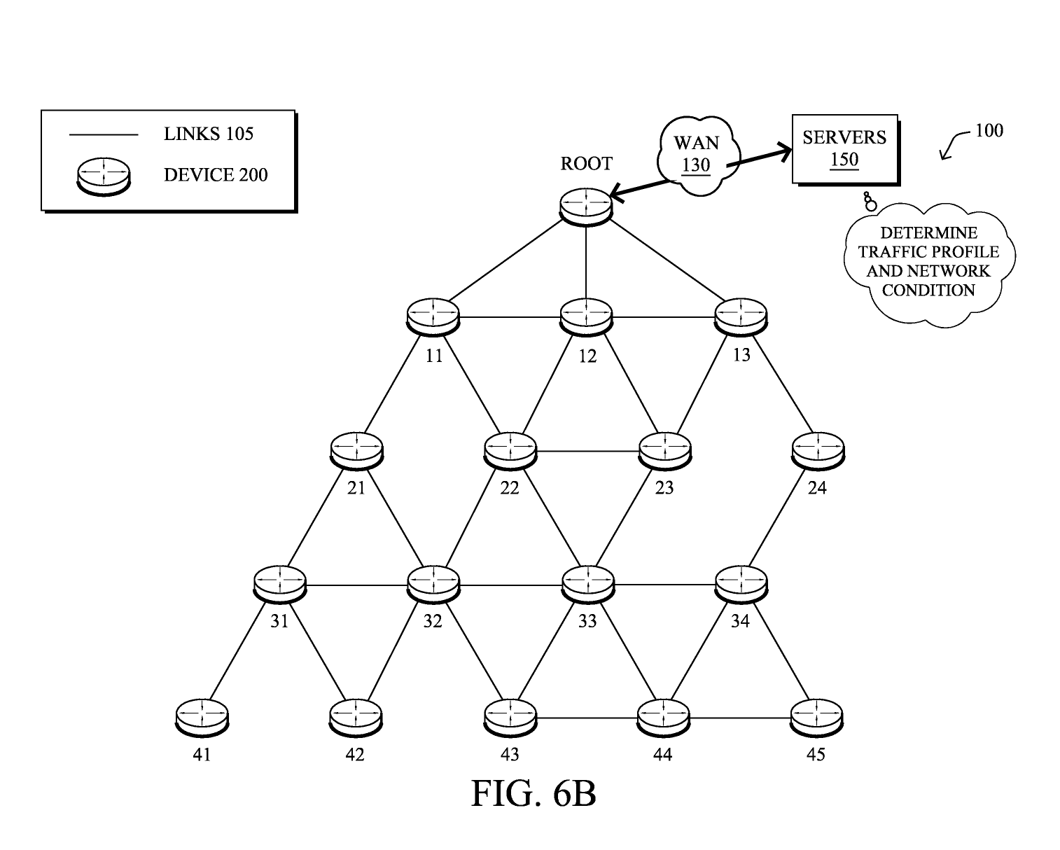

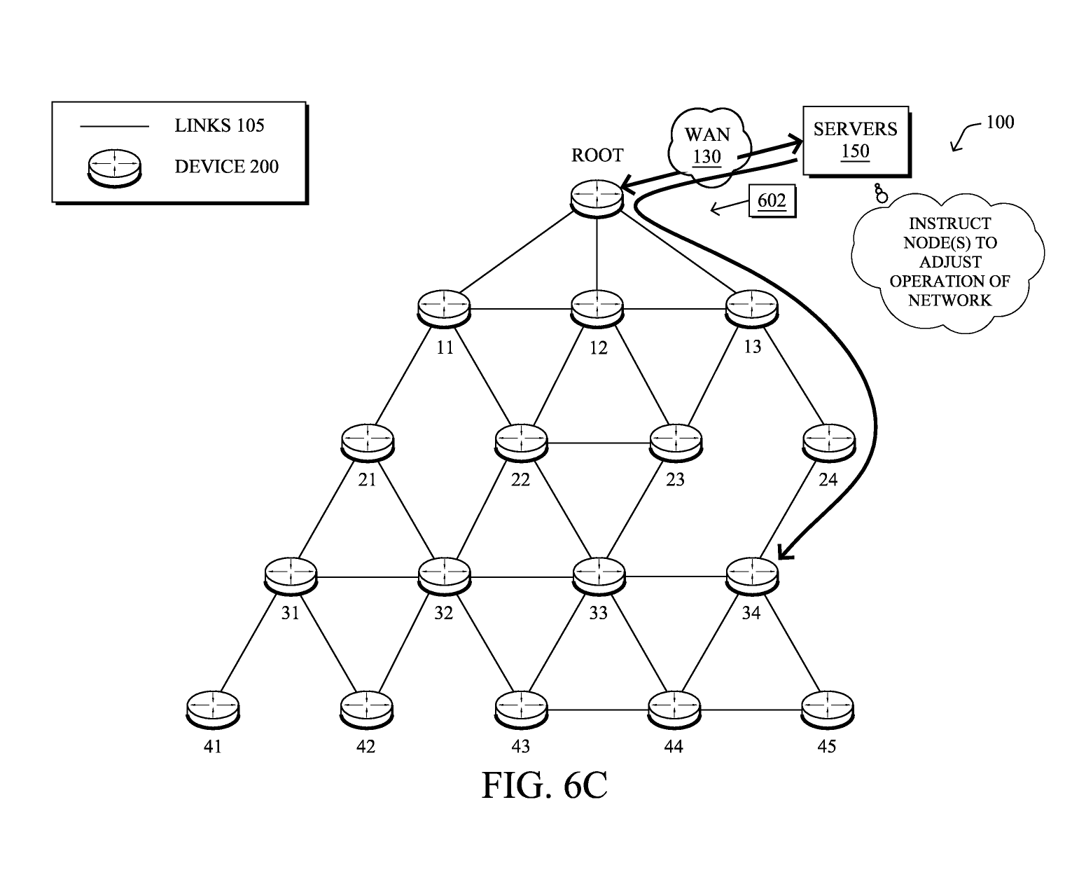

Referring now to FIGS. 6A-6C, an example of a supervisory device adjusting an operation of the network is shown, according to various embodiments. In one embodiment, each device may have a local process (e.g., process 248) that changes network parameters based on sensor inputs, such as shown in the examples of FIGS. 5A-5D. In other embodiments, however, a supervisory device in the network may change network parameters for one or more other network devices based on sensor data received from the one or more other devices. For example, as shown in FIG. 6A, node 34 may provide sensor data 502 to a supervisory device. In various embodiments, the supervisory device may be the local FAR/root node, one of servers 150 (e.g., an NMS, an application-specific server, etc.), or another node in the network configured to adjust an operation of the network.

In some cases, the supervisory device may aggregate sensor data from multiple devices in the network and use the aggregated sensor data to control the operational parameters of the devices (e.g., based on a difference in sensor measurements between the devices, etc.). For example, as shown in FIG. 6B, the supervisory device (e.g., one or servers 150) may determine the traffic profile and network condition using the received sensor data 502 from node 34 and/or from other nodes in the network. In some cases, the reporting LLN nodes may construct traffic models and report the traffic models to the supervisory device for use (e.g., via a custom IPv6 message, etc.). For example, a node deeper in the network may build a traffic model (e.g., a multi-Gaussian model, etc.) and provide it to the supervisory device (e.g., the FAR, NMS, etc.). In turn, the supervisory device may use the traffic model(s) to determine which nodes require parameter adjustments. For example, the supervisory device may determine that the operational parameters of only a subset of nodes require adjustment.

As shown in FIG. 6C, the supervisory device may adjust an operation of the network by sending an instruction 602 to one or more other devices in the network. For example, the NMS may send instruction 602 to node 34 indicating that node 34 should increase the frequency at which node 34 evaluates the quality of the links between node 34 and its neighbors.

In further embodiments, any node in network 100 may act as a supervisory device over one or more other nodes/devices, for purposes of adjusting network operations. For example, a particular network node/device may adjust network parameters and trigger other actions at one or more other devices based on its own sensor inputs (e.g., by sending instruction 602 to the one or more other devices). For example, an occupancy sensor may not be on the same device as a light switch. In such a case, once the occupancy sensor detects activity, the device equipped with the occupancy sensor may instruct the light switch to prepare for communication with the lights.

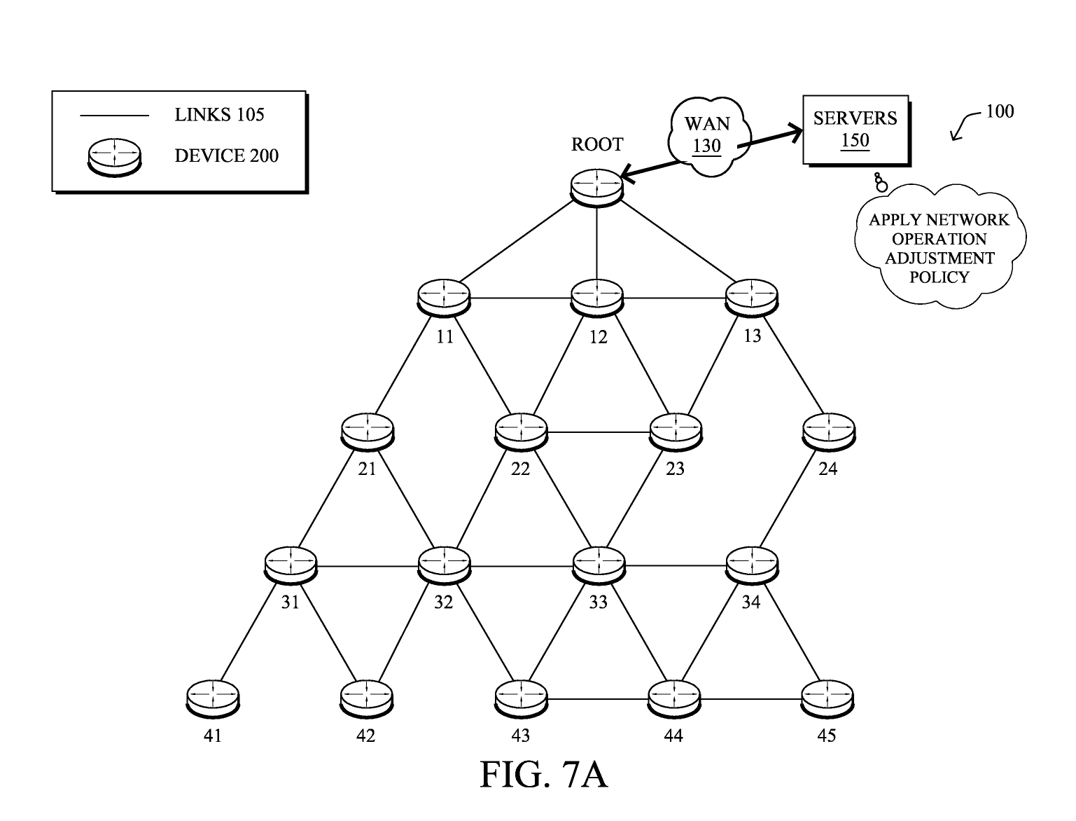

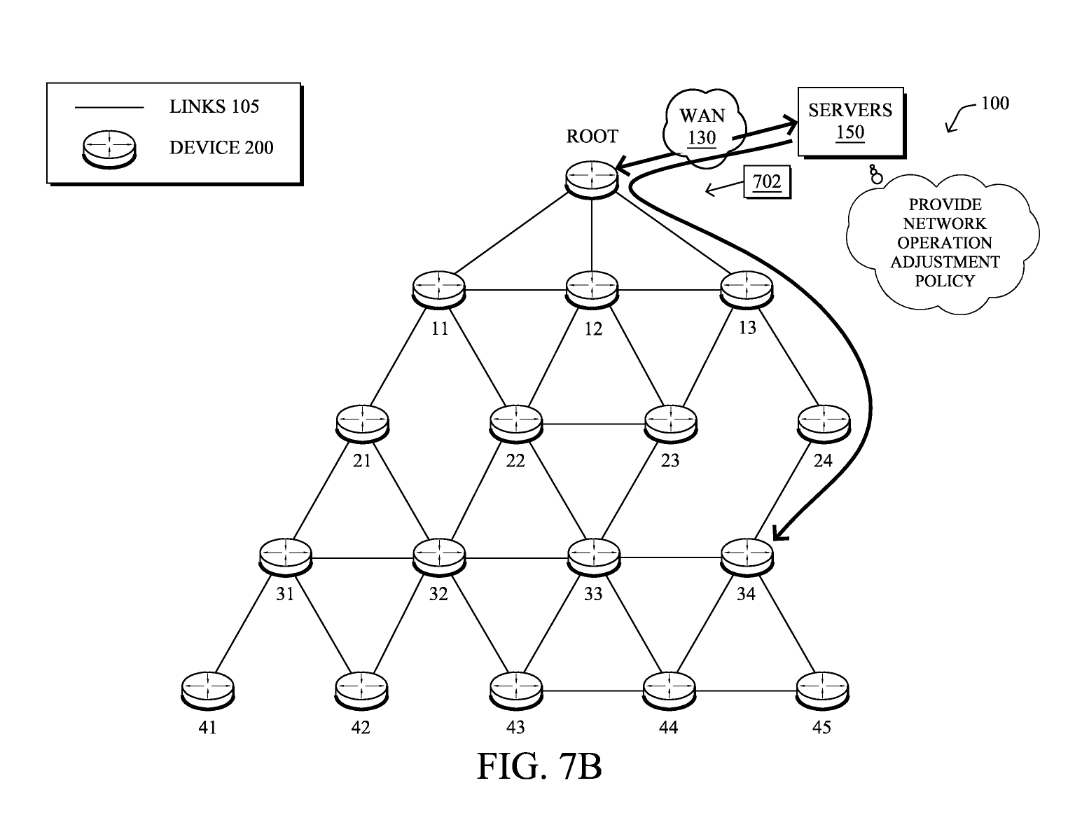

Referring now to FIGS. 7A-7B, examples are shown of a network operation adjustment policy being used, according to various embodiments. In some aspects, a FAR/Root, NMS, or other supervisory network device may function as a policy engine by maintaining a network operation adjustment policy that controls how and when adjustments to the operation of the network are made. For example, such a policy may indicate which parameters may be adjusted, allowable parameter values (e.g., a range of parameter values, etc.), and/or the conditions under which network operations should be adjusted. Generally, the network operation adjustment policy may function to ensure that certain service level agreements (SLAs) or other network characteristics are maintained, since full optimization in response to physical sensor data may not be appropriate given user-level requirements.

In one embodiment, the policy engine may compute and apply the network operation adjustment policy itself, if the policy engine also acts as a supervisory device for purposes of adjusting network operations. For example, as shown in FIG. 7A, a supervisory device (e.g., NMS, FAR/Root, etc.) may apply the network operation adjustment policy when determining whether to adjust network operations. In other embodiments, the policy engine may provide the policy to one or more network nodes that adjust their own operations and/or control the operations of other devices based on physical sensor data. For example, as shown in FIG. 7B, the NMS, FAR/Root, or other device acting as a policy engine may provide network operation adjustment policy 702 to node 34. In turn, node 34 may use policy 702 determine whether to adjust any of its local parameters and/or adjust the parameters of any other network device that it supervises.

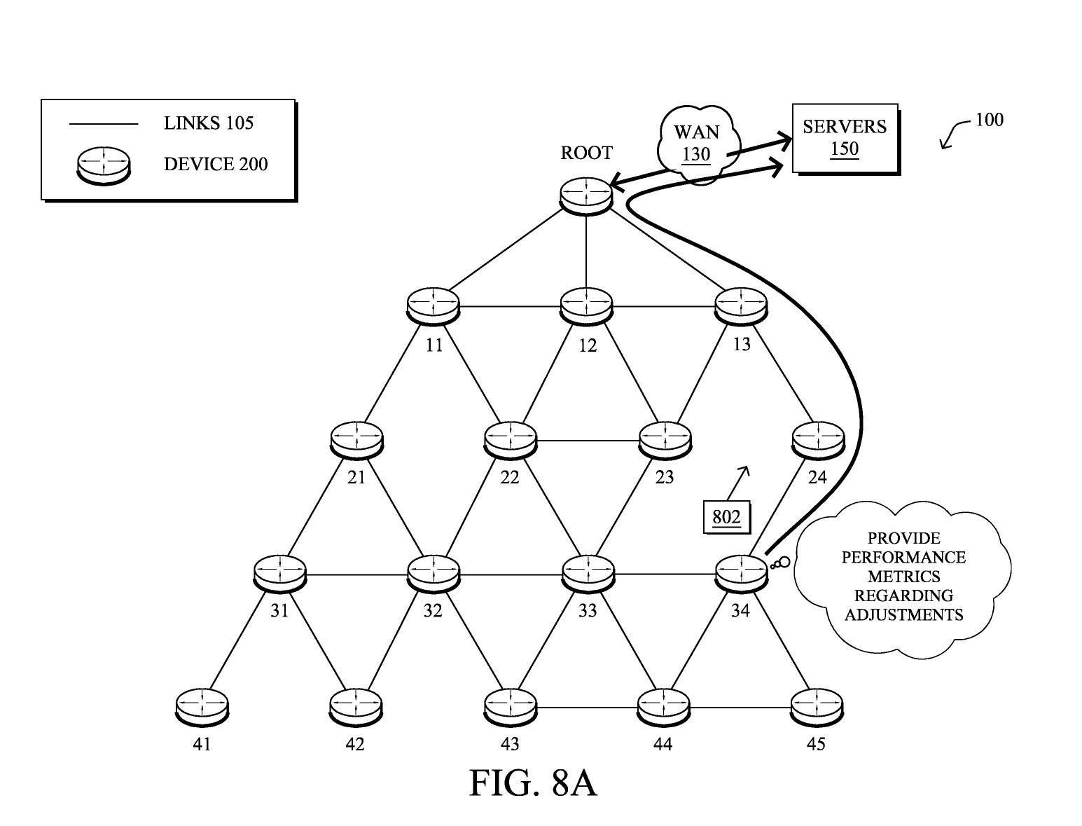

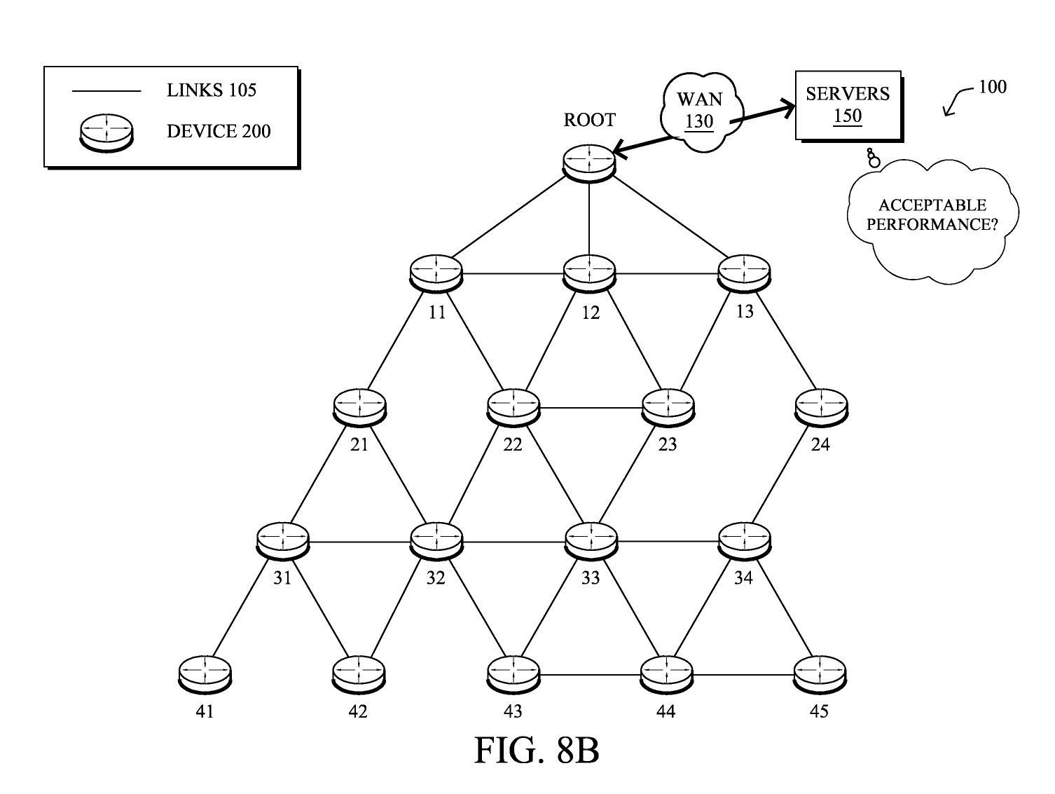

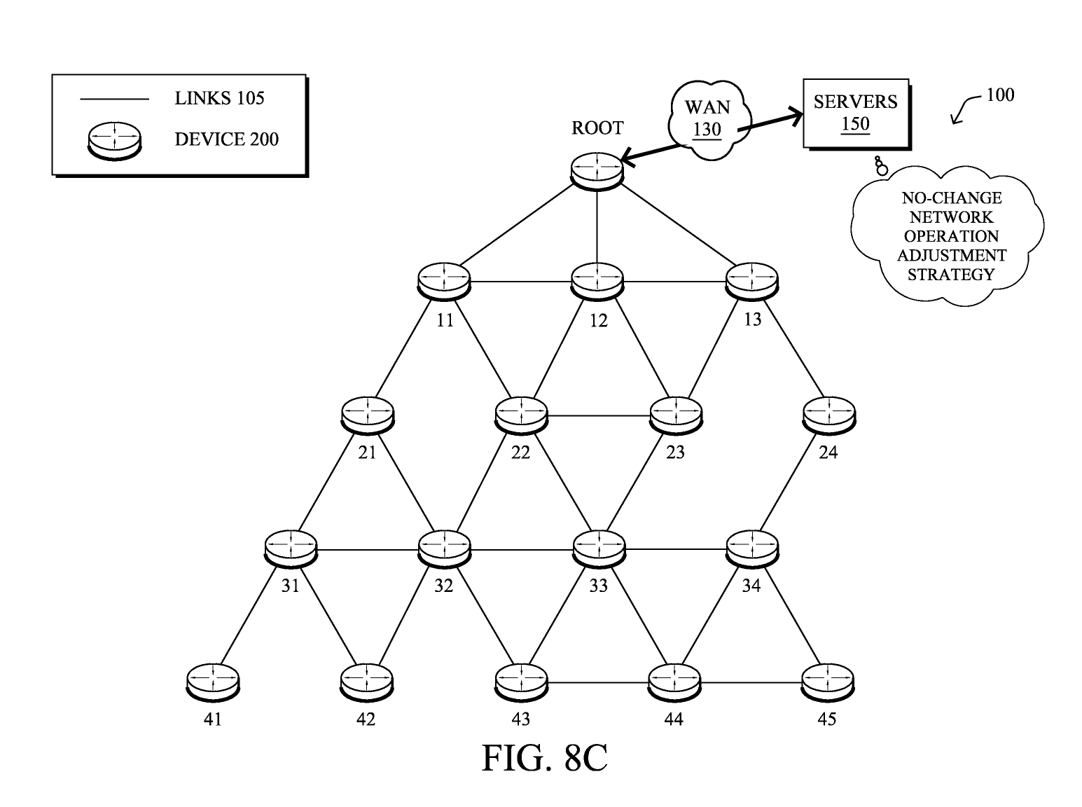

FIGS. 8A-8C illustrate a feedback mechanism for network operation adjustments, according to various embodiments. In some aspects, the techniques herein may employ a feedback mechanism to fine tune the actions taken in response to sensor readings. For example, as shown in FIG. 8A, device 34 determine network performance metrics 802 taken in response to adjusting a network operation and provide metrics 802 to the FAR/Root, NMS, or other device configured to control network adjustments. For example, the NMS, FAR, etc. may obtain network performance metrics from one or more network nodes during each traffic profile/network state determined by the model (e.g., DAG stability metrics, end-to-end latency metrics, etc.).

As shown in FIG. 8B, the device monitoring the network performance changes that result from a network operation adjustment may determine whether the network performance metrics are within an acceptable range. In one embodiment, the device may make this determination based in part on user feedback received from a user interface (e.g., a keyboard, touch screen display, pointing device, etc.). For example, a network administrator may indicate whether or not the administrator was satisfied with the network performance due to a change in one or more network operational parameters. In other embodiments, the acceptability may be based on existing policies used in the network (e.g., SLAs, etc.).

If the network performance after an adjustment is made to the operation of the network is not acceptable, the device may adjust the network operation adjustment strategy, as illustrated in FIG. 8C. For example, the device may make less drastic changes to the operation of the network the next time similar external conditions are detected, adjust different network parameters, or even prevent the adjustment from taking place again. Conversely, the device may use acceptable performance metrics to reinforce certain adjustments. For example, if the device adjusted network operational parameters in response to a detected weather condition, and the resulting performance metrics were acceptable, the device may promote the use of the same adjustment when the same or similar weather conditions are expected in the future. In cases in which the operational adjustments are made by a remote device (e.g., one of nodes 11-45) and not the device evaluating the results of the adjustment, the device that evaluates the results of the adjustment may instruct the remote device to change its adjustment strategy, accordingly.

In one example of operation, assume that a network device associates a detected temperature change of five degrees with an amount of clock synchronization error across network nodes. In such a case, the device may change the frequency of the clock synchronization messages in the network by an amount proportional to the temperature change (e.g., every Y seconds). However, if the clock synchronization messages are sent too frequently, the messages may impinge on the other traffic in the network, due to the increased use of network resources (e.g., by increasing path delays, etc.). In such a case, the device overseeing the operation adjustments to the network may receive performance data regarding the change and, in turn, change the operation adjustment strategy (e.g., by decreasing the frequency of clock synchronization messages if an increase in path delays is detected, etc.).

As would be appreciated, the techniques herein support operational adjustments that may be based on both known and unknown conditions. Notably, there may exist a number of known external conditions that can be used to predict the traffic profile and/or network state. For example, the presence of heavy fog may negatively impact link quality, as specified by a network administrator. However, there may also exist any number of unknown conditions that can also influence the traffic profile and/or network condition. The effects of these conditions may also vary on a per-deployment basis for the same application. In such cases, the use of machine learning according to the teachings herein may also provide the detection of unknown or unexpected correlations between physical conditions external to the network and the traffic profile/condition of the network.

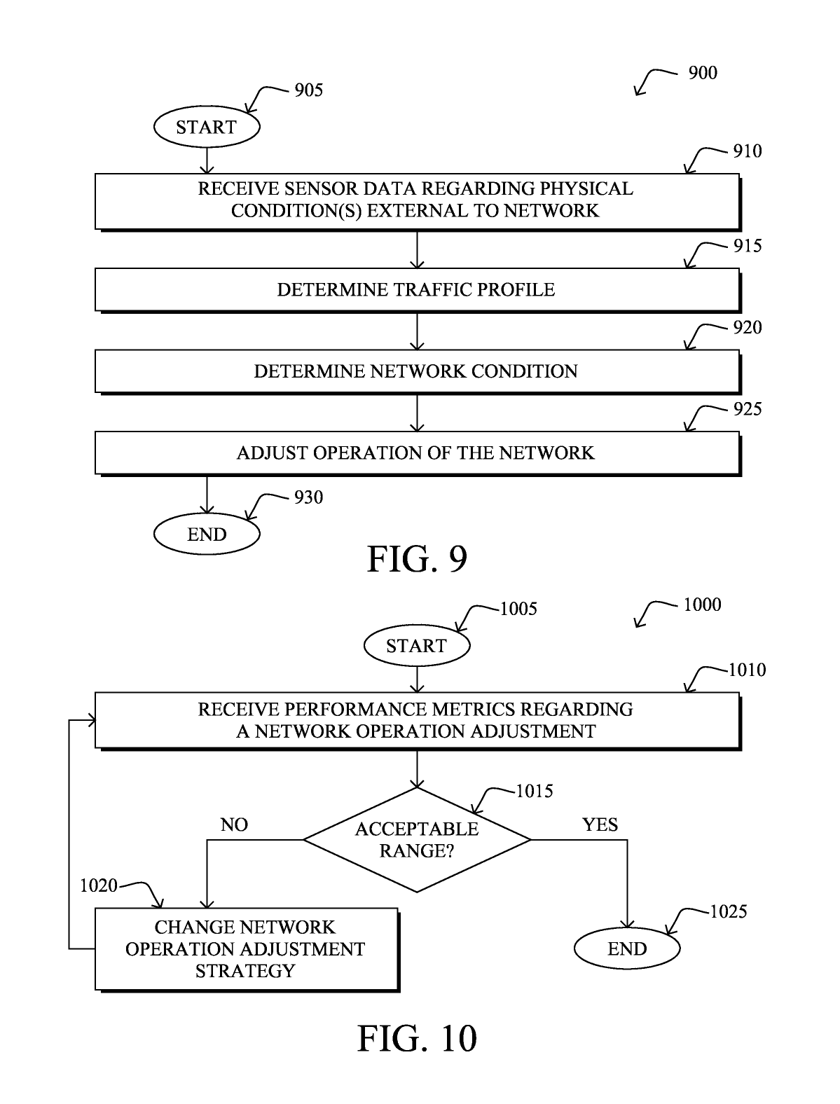

FIG. 9 illustrates an example simplified procedure for adjusting an operation of a network based on a physical condition external to the network, in accordance with one or more embodiments described herein. The procedure 900 may start at step 905, and continues to step 910, where, as described in greater detail above, a device in a network receives sensor data regarding one or more physical conditions external to the network. In one embodiment, the device may receive the sensor data from one or more sensors local to the device. In another embodiment, the device may receive the sensor data from one or more other devices in the network (e.g., the device may act as a supervisory device that controls some or all of the operations of the other devices). The sensor data may be raw data from a sensor (e.g., a voltage measurement, etc.) or data derived therefrom (e.g., a calculated value, a statistic, etc.).

In general, the received sensor data may relate to environmental or other external conditions that may exist regardless of the presence of the network. In other words, in contrast to measurements that are directly tied to the network itself (e.g., delays, jitter, packet loss, etc.), the received sensor data may relate to external conditions that may exist even if the network were not present in a particular location. For example, the received sensor data may include, but is not limited to, temperature data, humidity data, vibration data, building occupancy data (e.g., the use of lights, data from a security system, etc.), light intensity data, data indicative of a detected motion, accelerometer data, combinations thereof, or the like.

At step 915, as detailed above, the device may determine a network traffic profile based on the received sensor data. Notably, the device may map or otherwise associate an external condition of the network with a change in the traffic sent via the network. For example, a change in building occupancy or a detected motion (e.g., a user entering a room in which a particular network node is located, etc.) may be associated with a change in the traffic profile of the network. In one embodiment, the mapping may be set by a network administrator or other authorized user via a user interface. In another embodiment, the device may learn the mapping over time using a machine learning model that analyzes changes in the sensor data and the traffic profile in the network.

At step 920, the device may determine a condition of the network based on the received sensor data, as described in greater detail above. As noted above, the received sensor data may relate to external conditions outside of the network that may exist regardless of the actual state of the network. However, and particularly in the case of LLNs, these external conditions may still affect the actual performance of the network. For example, a detected increase in the occupancy of a building may also correspond to an increase in doors opening and closing, thereby affecting wireless communications between devices. Similar to the determined traffic profile, the device may determine the network condition based on a mapping set by an administrative user (e.g., via a user interface) or may be learned by the device using machine learning (e.g., by training a predictive model).

At step 925, as detailed above, the device adjusts an operation of the network. In various embodiments, the device may adjust the operation of the network based on the traffic profile and/or the network condition determined in steps 915, 920. In general, the device may adjust the operation of the network by adjusting one or more parameters that affect the routing topology, affect clock synchronization between network devices, control routing decisions, control an energy conservation mechanisms used by network devices, control traffic flows, and/or affect one or more network performance metrics. In various embodiments, the device may adjust the operation of the network by changing its own behavior, by instructing one or more nodes in the network to adjust their behavior, or both. In some embodiments, the device may adjust the operation of the network based on a network operation adjustment policy (e.g., received via a user interface, received from a supervisory device, etc.). In cases in which the device maintains the adjustment policy, the device may monitor network performance metrics and change the policy if the performance metrics are outside of an acceptable range. Procedure 900 then ends at step 930.

FIG. 10 illustrates an example simplified procedure for using feedback to change a network operation adjustment strategy, in accordance with one or more embodiments herein. Procedure 1000 may begin at step 1005 and continue on to step 1010 where, as described in greater detail above, a device in a network may receive performance metrics regarding an adjustment made to the operation of the network. For example, based on sensor data related to one or more physical conditions external to the network, the device may adjust one or more network parameters. In response, the device may receive any number of performance metrics for the network, to assess the effects of the adjustment on the network. The performance metrics may include, but are not limited to, device metrics (e.g., queue lengths, available resources, etc.), link metrics (e.g., delay, jitter, bandwidth, etc.), or any other metrics that can be used to quantify the performance of the network.

At step 1015, as detailed above, the device makes a determination as to whether or not the performance metrics fall within an acceptable range. For example, in some embodiments, the device may determine whether or not any application SLAs are being met using the performance metrics. If so, procedure 1000 may continue on to step 1025 and end. However, if the device determines that the performance is not within an acceptable range, procedure 1000 may continue on to step 1020.

At step 1020, the device changes the network operation adjustment strategy in use within the network. In general, such a strategy controls how and when adjustments are made to the operation of the network in response to physical sensor data. For example, the device may change which parameters are adjusted, the parameter values used during an operation adjustment, an adjustment policy sent to another device, or the like, if the resulting performance after the previous operation adjustment was not acceptable. Procedure then continues on to step 1010. In various embodiments, procedure 1000 may be repeated iteratively any number of times until acceptable network performance is achieved or, in some cases, until a timeout event occurs (e.g., after a set number of failed adjustments, after receiving a stop command from a user interface, etc.). Thus, procedure 1000 may enable the network to use a feedback loop to control when and how operation adjustments are made.

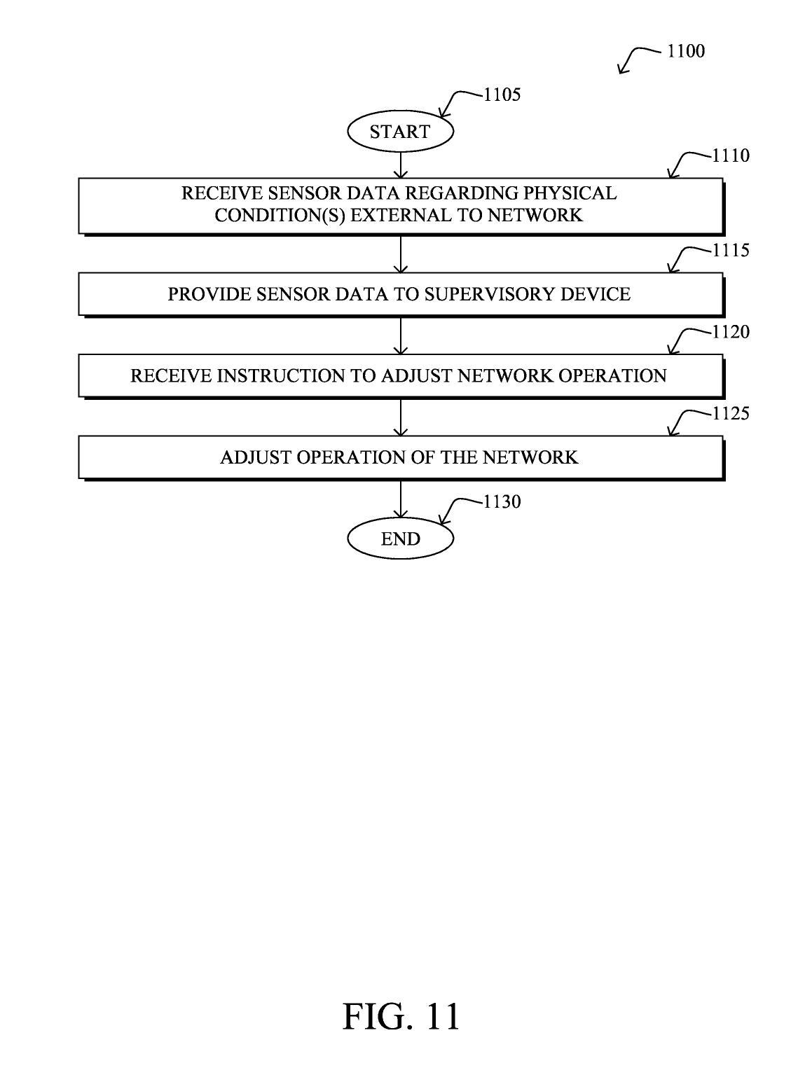

FIG. 11 illustrates an example simplified procedure for using a supervisory device to adjust an operation of a network based on a physical condition external to the network, in accordance with one or more embodiments described herein. The procedure 1100 starts at step 1105 and continues on to step 1110 where, as described in greater detail above, a first device in a network receives sensor data from one or more sensors configured to measure one or more physical conditions external to the network. In various embodiments, the first device may comprise the one or more sensors or may be otherwise communicatively coupled to the one or more sensors.

At step 1115, the first device provides the sensor data to a supervisory device, as detailed above. Such a supervisory device may be a root node/FAR, a supervisory server (e.g., NMS, etc.), or another network node configured to provide control over some or all of the operations of the network. For example, the first device may provide a temperature reading, a light measurement, a humidity measurement, a vibration measurement, data indicative of a building occupancy, etc. to the supervisory device.

At step 1120, the first device receives an instruction from the supervisory device to adjust an operation of the network, as described in greater detail above. Such an instruction may be based on the sensor data provided by the first device to the supervisory device. For example, the supervisory device may instruct the first device to adjust how the first device synchronizes its clock to that of the network, how the first device routes data, when the first device measures network or link performance, when the first device initiates a routing topology change, etc., based on the sensor data provided to the supervisory device.

At step 1125, as detailed above, the first device adjusts the operation of the network, in response to receiving the instruction in step 1120. In various examples, the first device may adjust a frequency at which link qualities in the network are evaluated, adjust a frequency at which routing updates are propagated in the network, adjust a frequency at which clock synchronization messages are sent in the network, or construct a routing path between two or more nodes in the network, or perform any other change to the operation of the network. Procedure 1100 then ends at step 1130.

It should be noted that while certain steps within procedures 900-1100 may be optional as described above, the steps shown in FIGS. 9-11 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 900-1100 are described separately, certain steps from each procedure may be incorporated into each other procedure, and the procedures are not meant to be mutually exclusive.

The techniques described herein, therefore, provide a mechanism for dynamically adjusting network operations (e.g., by adjusting one or more parameters) based on any physical sensor data available to a network device. By using the physical sensor data, the device can predict changes in the traffic profile and/or network state and, in turn, make any necessary tradeoffs in terms of application requirements. Such techniques allow for networks to have longer lifetimes while offering greater robustness, lower latency, and an overall better user experience.

While there have been shown and described illustrative embodiments that provide for dynamically adjusting network operations based on physical sensor data, it is to be understood that various other adaptations and modifications may be made within the spirit and scope of the embodiments herein. For example, the embodiments have been shown and described herein with relation to LLNs. However, the embodiments in their broader sense are not as limited, and may, in fact, be used with other types of shared-media networks and/or protocols (e.g., wireless). In addition, while certain protocols are shown, such as RPL, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
receiving, at a device in a network, sensor data regarding one or more physical conditions external to the network;
determining, by the device, at least one of: a traffic profile based on the sensor data or a condition of the network based on the sensor data; and
adjusting, by the device, an operation of the network, based on the at least one of the determined traffic profile or the determined condition of the network.

2. The method as in claim 1, wherein the one or more physical conditions external to the network comprises at least one of: an amount of light, an external temperature, an amount of humidity, an amount of noise, an atmospheric pressure, an amount of vibration, or a building occupancy.

3. The method as in claim 1, wherein determining the traffic profile based on the sensor data comprises:
using, by the device, the sensor data as input to a machine learning model that maps traffic profiles to sensor data.

4. The method as in claim 3, further comprising:
training, by the device, the machine learning model.

5. The method as in claim 1, wherein determining the traffic profile based on the sensor data comprises:
using, by the device, the sensor data as input to a configured mapping between sensor data and traffic profiles received by the device via a user interface.

6. The method as in claim 1, wherein the sensor data is received by the device from a plurality of nodes in the network.

7. The method as in claim 1, wherein the operation of the network is adjusted by the device according to a network operation adjustment policy.

8. The method as in claim 7, further comprising:
receiving, at the device, the network operation adjustment policy from a supervisory device.

9. The method as in claim 1, wherein the device is a field area router or a network management system.

10. The method as in claim 1, wherein adjusting the operation of the network comprises at least one of: adjusting a frequency at which link qualities in the network are evaluated, adjusting a frequency at which routing updates are propagated in the network, adjusting a frequency at which clock synchronization messages are sent in the network, switching between reactive and proactive routing mechanisms, switching between building a multicast routing tree and flooding multicast messages, adjusting network capacities for broadcast and unicast traffic, switching between using broadcast transmissions and sending a plurality of unicast messages, or constructing a routing path between two or more nodes in the network.

11. The method as in claim 1, wherein adjusting the operation of the network comprises:
instructing, by the device, one or more nodes in the network to adjust the operation of the network.

12. The method as in claim 1, further comprising:
receiving, at the device, performance metrics regarding the adjusted operation of the network;
determining, by the device, whether the performance metrics are within an acceptable range; and
changing, by the device, a network operation adjustment strategy, in response to a determination that the performance metrics are not within the acceptable range.

13. The method as in claim 12, wherein the determination that the performance metrics are not within the acceptable range is based on input received via a user interface.

14. A method, comprising:
receiving, at a first device in a network, sensor data from one or more sensors configured to measure one or more physical conditions external to the network;
providing, by the first device, the sensor data to a supervisory device in the network;
receiving, at the first device, an instruction from the supervisory device to adjust an operation of the network, in response to providing the sensor data to the supervisory device; and
adjusting, by the first device, the operation of the network, in response to receiving the instruction from the supervisory device.

15. The method as in claim 14, wherein the one or more physical conditions external to the network comprises at least one of: an amount of light, an external temperature, an amount of humidity, an amount of noise, an atmospheric pressure, an amount of vibration, or a building occupancy.

16. The method as in claim 14, wherein adjusting the operation of the network comprises at least one of: adjusting a frequency at which link qualities in the network are evaluated, adjusting a frequency at which routing updates are propagated in the network, adjusting a frequency at which clock synchronization messages are sent in the network, switching between reactive and proactive routing mechanisms, switching between building a multicast routing tree and flooding multicast messages, adjusting network capacities for broadcast and unicast traffic, switching between using broadcast transmissions and sending a plurality of unicast messages, or constructing a routing path between two or more nodes in the network.

17. The method as in claim 14, further comprising:
providing, by the first device, performance metrics regarding the adjusted operation of the network to the supervisory device.

18. The method as in claim 14, wherein the supervisory device is a field area router, another node in the network, or a network management system.

19. An apparatus, comprising:
one or more network interfaces to communicate with a network;
a processor coupled to the one or more network interfaces and configured to execute one or more processes; and
a memory configured to store a process executable by the processor, the process when executed operable to:
receive sensor data regarding one or more physical conditions external to the network;
determine at least one of: a traffic profile based on the sensor data or a condition of the network based on the sensor data;
adjust an operation of the network, based on the at least one of the determined traffic profile or the determined condition of the network.

20. The apparatus as in claim 19, wherein the one or more physical conditions external to the network comprises at least one of: an amount of light, an external temperature, an amount of humidity, an amount of noise, an atmospheric pressure, an amount of vibration, or a building occupancy.

21. The apparatus as in claim 19, wherein the apparatus adjusts the operation of the network by at least one of: adjusting a frequency at which link qualities in the network are evaluated, adjusting a frequency at which routing updates are propagated in the network, adjusting a frequency at which clock synchronization messages are sent in the network, switching between reactive and proactive routing mechanisms, switching between building a multicast routing tree and flooding multicast messages, adjusting network capacities for broadcast and unicast traffic, switching between using broadcast transmissions and sending a plurality of unicast messages, or constructing a routing path between two or more nodes in the network.

22. The apparatus as in claim 19, further comprising one or more sensors configured to generate the sensor data.

23. An apparatus, comprising:
one or more network interfaces to communicate with a network;
a processor coupled to the one or more network interfaces and configured to execute one or more processes; and
a memory configured to store a process executable by the processor, the process when executed operable to:
receive sensor data from one or more sensors configured to measure one or more physical conditions external to the network;
provide the sensor data to a supervisory device in the network;
receive an instruction from the supervisory device to adjust an operation of the network, in response to providing the sensor data to the supervisory device; and
adjust the operation of the network, in response to receiving the instruction from the supervisory device.

24. The apparatus as in claim 23, wherein the one or more physical conditions external to the network comprises at least one of: an amount of light, an external temperature, an amount of humidity, an amount of noise, an atmospheric pressure, an amount of vibration, or a building occupancy.

25. The apparatus as in claim 23, wherein the apparatus adjusts the operation of the network by at least one of: adjusting a frequency at which link qualities in the network are evaluated, adjusting a frequency at which routing updates are propagated in the network, adjusting a frequency at which clock synchronization messages are sent in the network, switching between reactive and proactive routing mechanisms, switching between building a multicast routing tree and flooding multicast messages, adjusting network capacities for broadcast and unicast traffic, switching between using broadcast transmissions and sending a plurality of unicast messages, or constructing a routing path between two or more nodes in the network.
